(19) United States
(12) Patent Application Publication
(10) Pub. No.: US 2009/0083110 A1
(43) Pub. Date: Mar. 26, 2009

(54) FORMAL MODEL FOR BUSINESS PROCESSES

(76) Inventors: Ivan Markovic, Karlsruhe (DE); Alessandro Costa Pereira, Bairro Medicina (BR)

Correspondence Address: SCHWEGMAN, LUNDBERG & WOESSNER/SAP, P.O. BOX 2938, MINNEAPOLIS, MN, 55402, US

(21) Appl. No.: 11/859,450

(22) Filed: Sep. 21, 2007

(51) Int. Cl. G06Q 10/00; G06F 17/10; G06F 17/30; G06F 17/40

(52) U.S. Cl. 705/9

(57) ABSTRACT

Various embodiments described herein provide one or more of systems, methods, and software for formal modeling of business processes. Some embodiments provide a formal model for business processes that allows for expressive querying and reasoning over process models. Some such models provide mechanisms for rich descriptions of processes from different workflow perspectives that may allow automated process verification, simulation, execution, and querying in the process space. Some embodiments include receiving a mapping of at least a portion of a process and determining an order of tasks of the process as a function of π-calculus formulas associated with each type of the tasks of the process map. The ordered tasks may then be translated into a process modeling language representation of the at least a portion of the process.

### BACKGROUND INFORMATION

Business process modeling has become a crucial phase in the development of enterprise information systems. Business process models are created by business users with an objective to capture business requirements, enable a better understanding of business processes, facilitate communication between business analysts and IT experts, identify process improvement options, and serve as a basis for derivation of executable business processes. Designing a new process model is a highly complex, time consuming, and error prone task.

### BRIEF DESCRIPTION OF THE DRAWINGS

FIG. 1 is a block diagram of a computing device according to an example embodiment.

FIG. 2 is a block diagram of a system according to an example embodiment.

FIG. 3 illustrates example workflow patterns according to an example embodiment.

FIG. 4 illustrates dependencies between Business Process Description Ontology and Business Core Ontology according to an example embodiment.

FIG. 5 illustrates a Business Process Description Ontology hierarchical representation of the π-calculus language according to an example embodiment.

FIG. 6 illustrates example Business Process Description Ontology annotations according to an example embodiment.

FIG. 7 illustrates an example process fragment model according to an example embodiment.

FIG. 8 is a block flow diagram of a method according to an example embodiment.

### DETAILED DESCRIPTION

Various embodiments described herein provide one or more of systems, methods, and software for formal modeling of business processes. Some embodiments provide a formal model for business processes that allows for expressive querying and reasoning over process models. Some such models provide mechanisms for rich descriptions of processes from different workflow perspectives that may allow automated process verification, simulation, execution, and querying in the process space. Some embodiments include receiving a mapping of at least a portion of a process and determining an order of tasks of the process as a function of π-calculus formulas associated with each type of the tasks of the process map. The ordered tasks may then be translated into a process description modeling language representation of the at least a portion of the process. These and other embodiments are described in greater detail below.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in specific interconnected hardware modules or devices with related control and data signals communicated between and through the modules, or as portions of an application-specific integrated circuit. Thus, the exemplary process flow is applicable to software, firmware, and hardware implementations.

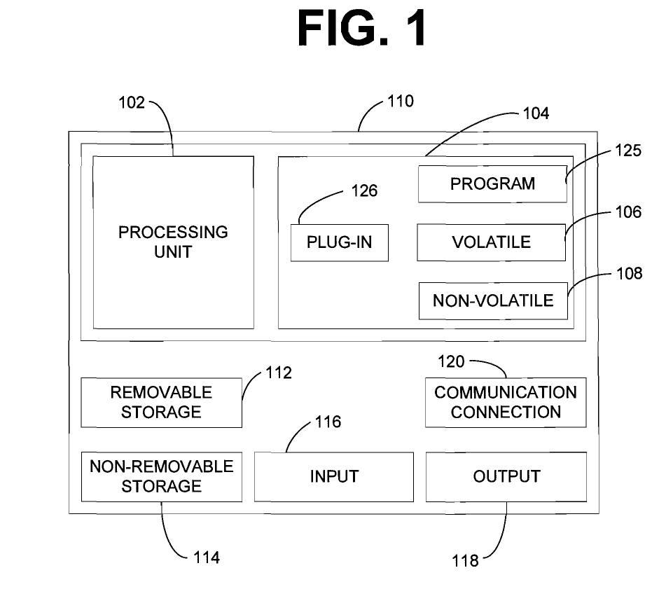

FIG. 1 is a block diagram of a computing device according to an example embodiment. In one embodiment, multiple such computer systems are utilized in a distributed network to implement multiple components in a transaction based environment. An object oriented architecture may be used to implement such functions and communicate between the multiple systems and components. One example computing device in the form of a computer 110, may include a processing unit 102, memory 104, removable storage 112, and non-removable storage 114. Memory 104 may include volatile memory 106 and non-volatile memory 108. Computer 110 may include—or have access to a computing environment that includes—a variety of computer-readable media, such as volatile memory 106 and non-volatile memory 108, removable storage 112 and non-removable storage 114. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 110 may include or have access to a computing environment that includes input 116, output 118, and a communication connection 120. The computer may operate in a networked environment using a communication connection to connect to one or more remote computers, such as database servers. The remote computer may include a personal computer (PC), server, router, network PC, a peer device or other common network node, or the like. The communication connection may include a connection to one or more of a Local Area Network (LAN), a Wide Area Network (WAN), the Internet, or other networks.

Computer-readable instructions stored on a computer-readable medium are executable by the processing unit 102 of the computer 110. A hard drive, CD-ROM, and RAM are some examples of articles including a computer-readable medium. For example, the computer readable medium may include a computer program 125, such as a graphical process modeling tool allowing graphical modeling of processes. The graphical process modeling tool may include programs such as a model translation module or a plug-in 126 to translate process models to a process modeling language. In some embodiments, the computer program 125 provides mechanisms which may be utilized to model business processes in one or more notation formats. Examples of such notation formats may include one or more of the Business Process Modeling Notation (“BPMN”), Fundamental Modeling Concepts (“FMC”), Unified Modeling Language (“UML”), or other notation format.

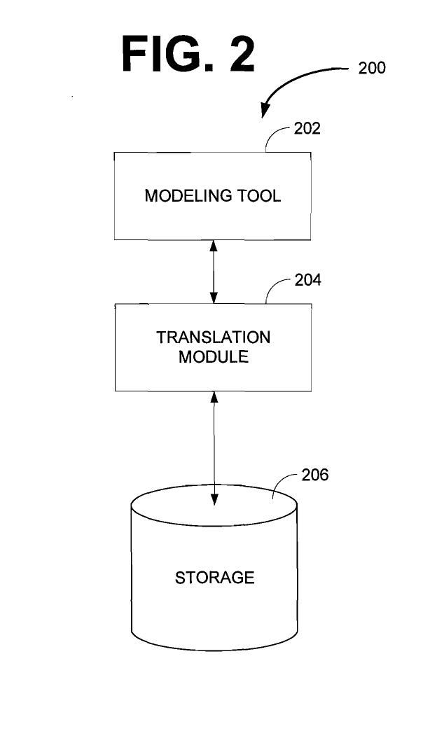

FIG. 2 is a block diagram of a system 200 according to an example embodiment. The system 200 includes a modeling tool 202, a translation module 204, and a storage mechanism 206.

In some embodiments, the modeling tool 202 is operable to receive input defining a model of a process. A process model typically includes tasks. As tasks are defined, metadata may be added to tasks or imported from a process modeling ontology from which a task may be instantiated from. A process modeling ontology may be specific to one or more of an organization, an industry, or even on a smaller level, such as department specific.

The data storage mechanism 206 may be a hard disk capable of storing relatively large amounts of data. In other embodiments, the data storage mechanism 206 may be another device such as a volatile or non-volatile memory, a magnetic or optical removable disk, or other data storage device. The data storage mechanism 206 may be located locally with the modeling tool 202 or on a remote storage device such as a remote server.

In some embodiments, the translation module 204, which may also be referred to as a process ontology translation module, is operable to receive a process model from the process modeling tool 202. The translation module 204 may then determine an order of tasks within the modeled process as a function of π-calculus formulas associated with each type of the tasks of the process map and translate the ordered tasks to a process modeling language representation of the at least a portion of the process. The translation module 204 may then store the modeling language representation of the modeled process on within the data storage mechanism 206. The modeling language may be Web Service Modeling Language (“WSML”) or other suitable modeling language.

In some embodiments, tasks included within the process model are selected from a number of task types available within a domain-specific process ontology and the task types may each include metadata defining properties of the task type. The modeling tool 202 may be used to modify such metadata such as properties which are configurable. In some embodiments, a process model created with a modeling tool 202 in conjunction with the translation module 204 may be used to create an ontology, such as a domain-specific ontology, which may be used in creation of other process models. When creating process models using one or more of such a domain-specific ontology, one or more of the tasks, task types, or other process elements or properties may be imported into the new model, in whole or in part, from the domain specific process ontology. However, a non-domain-specific ontology may also be utilized alone, or in conjunction with a domain-specific ontology.

In some embodiments, metadata of a task type may include one or more of metadata defining one or more process or task goals, functions, departments, roles, and resources. The metadata may include the π-calculus formulas that enable reasoning when determining the order of the tasks.

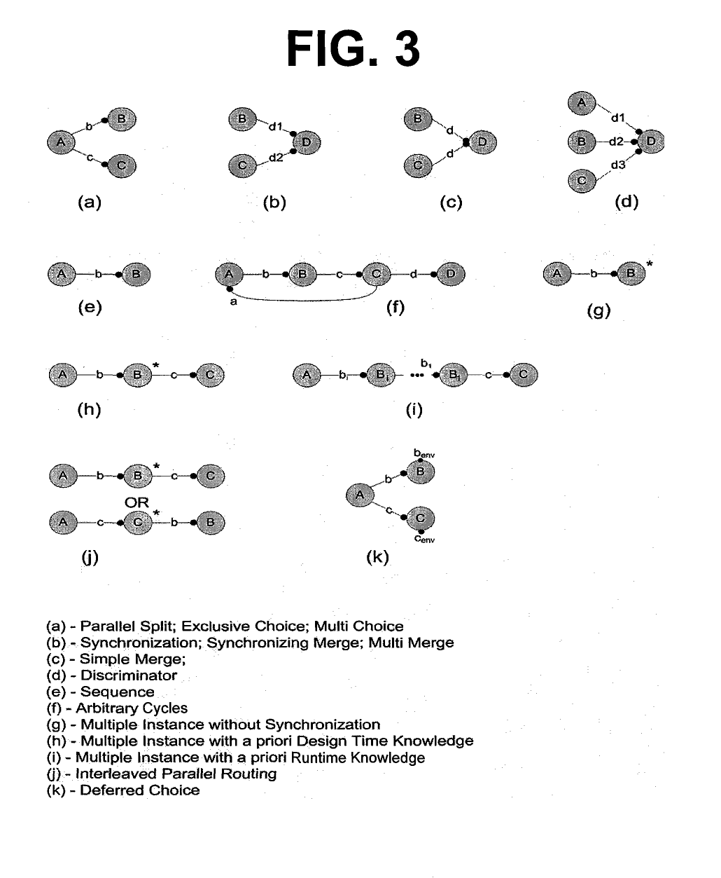

In some embodiments, the process ontology translation module 204 is operable to identify workflow patterns within a modeled process as a function of the π-calculus formulas associated with each type of the tasks of the process map. Some example workflow patterns are illustrated in FIG. 3.

The mathematical foundation used in typical embodiments to describe the behavior of business processes is referred to as π-calculus. π-calculus is a formal language for specifying mobile processes, which uses communication channel (name) interaction. Generally, the π-calculus consists of processes and names. An example of the π-calculus syntax is as follows:

P::=M|P|P|vzP|!P (1)

M::=0|π.P|M+M (2)

π::= x̅(y)|x(z)|τ|[x=y]τ (3)

Equation 1 is the definition of a process and it defines the following: P|P is a composition where processes P and P run in parallel—concurrent execution. vzP represents a restriction, which ensures that the name z is fresh. !P is the notation for a replication, where multiple instances of P run in parallel. The replication operator also satisfies the equation: !P=P|!P.

Equation 2 gives the summations behind M:0 is the inaction, a process that can do nothing. M+M is the exclusive choice between M and M. The π is a prefix.

Equation 3, finally, defines the prefix π: x̅(y) is the output prefix, which sends the name y over the name x and then continues as P. On the other hand, x(z) is the input prefix receiving any name over x, and then continues as P with z replaced by the received name. τ is an unobservable internal action of the process. The last symbol, the match prefix [x=y]π.P behaves as π.P, if x is equal to y.

The syntax of π-calculus is used as a basis for creating the grammar of the Business Process Definition Ontology explained below.

### Bisoness Process Description Ontology (“BPDO”)

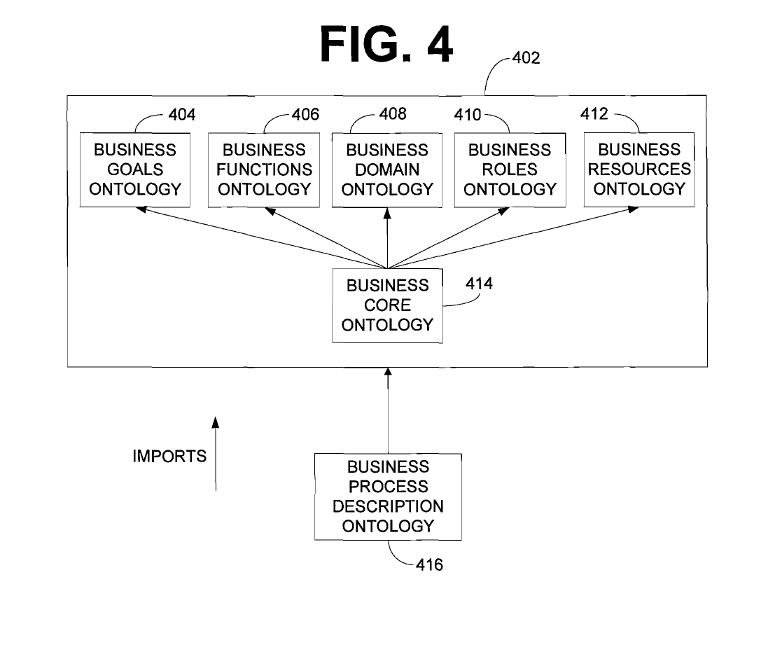

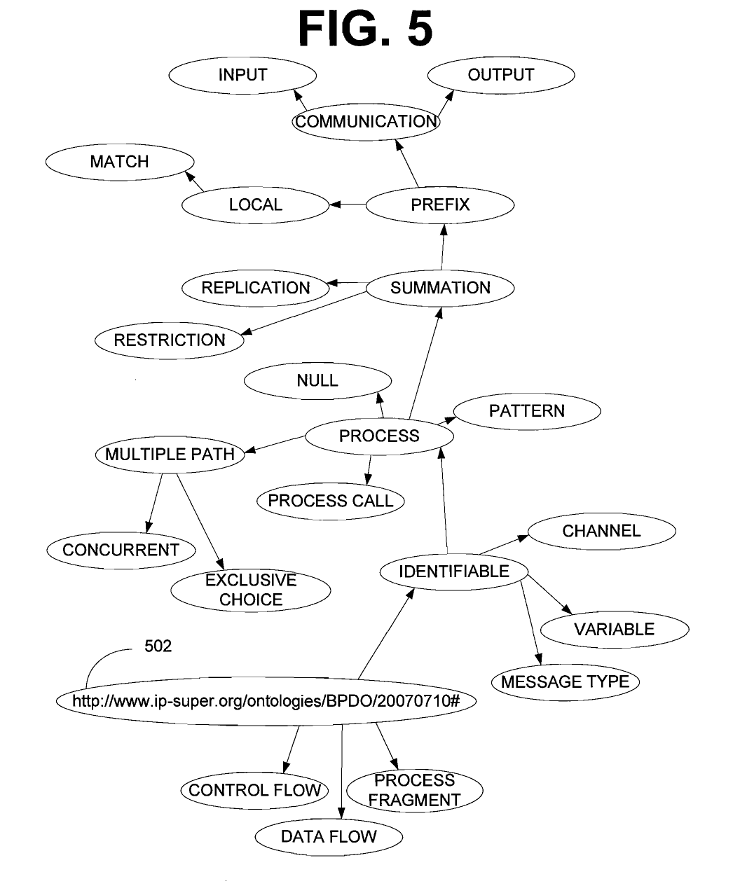

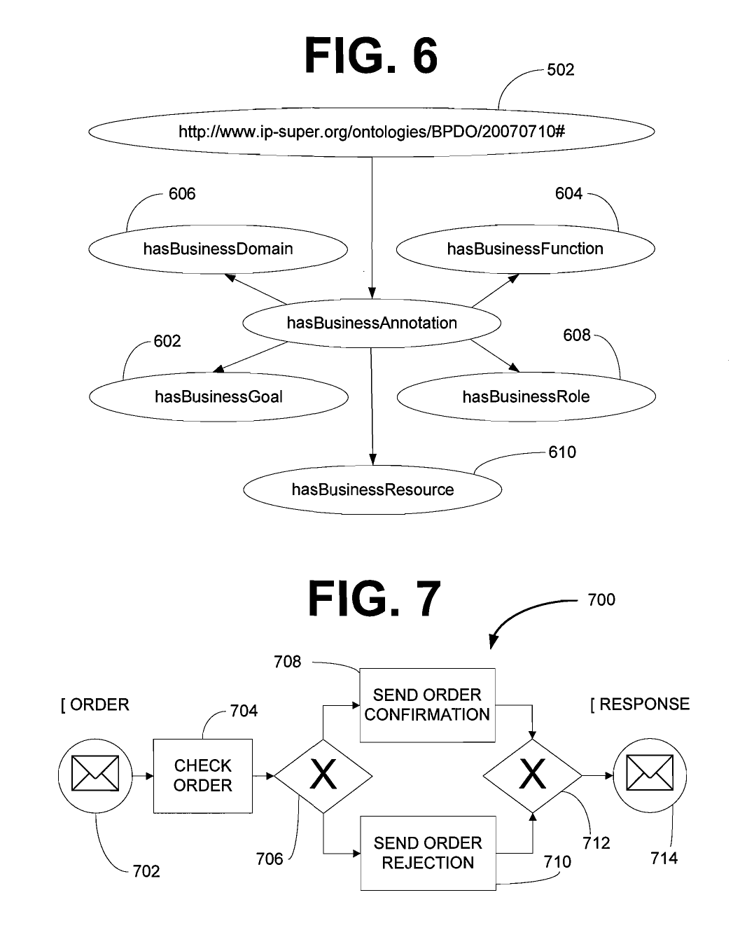

The BPDO will be described with reference to FIG, 4, FIG. 5, FIG. 6, FIG. 7, and Listing 1 included in the text below. FIG. 4 illustrates dependencies between Business Process Description Ontology and Business Core Ontology according to an example embodiment. FIG. 5 illustrates a Business Process Description Ontology hierarchical representation of the π-calculus language according to an example embodiment. FIG. 6 illustrates example Business Process Description Ontology annotations according to an example embodiment. FIG. 7 illustrates an example process fragment model according to an example embodiment. Listing 1 is a textual representation of the process fragment model of FIG. 7.

Various embodiments herein provide rich process description to allow holistic viewing of processes by perspectives. A process description ontology, in some embodiments, includes more than just workflow patterns as it also represents other workflow perspectives, such as perspectives by goals, functions, domains, roles, and resources. For this reason, some embodiments of the BPDO captures dynamic and static aspects of business processes. The information about a business process saved in the model may be rich, enabling (semi) automatic discovery, design, analysis, optimization, composition execution, etc., which may be discovered by performing queries against one or more process models by custom queries or by processes implementing other processes or ancillary functions that may operate for purposes such as resource or role planning. This may include resource planning based on resource and/or role data associated with a process model. For representing the dynamic aspect (behavioral semantics) of a process model, various embodiments may use process algebra, such as the π-calculus.

The π-calculus is described above with its syntax and constructors. The language is simple and suitable to constitute the foundation for the BPDO. Some such embodiments select the π-calculus as a theory for describing the dynamics of modern business process management systems. The π-calculus ontology is able to express the semantics of virtually all workflow patterns. Therefore, workflow representations may be modeled in the WSML language referencing BPDO concepts. The π-calculus representation of a process may describe from a behavioral perspective how processes or process activities are connected and how data and control passes between processes and process activities.

In order to integrate behavioral perspective with other workflow perspectives, BPDO imports concepts from the Business Core Ontology (“BCO”) as illustrated in FIG. 4. A BCO has the task to describe business and industry specific concepts and link them to the BPDO as illustrated in FIG. 5. A BCO 402, with reference to FIG. 4, describes concepts such as business goal 404, business function 406, business domain 408, business role 410, and business resource 412. These are concepts used to create semantic annotations for concrete process or process fragment definitions, such as business properties of processes. FIG. 4 illustrates dependencies between BPDO 416 and BCO 402 according to an example embodiment. The BCO 414 operates to link the annotations 404, 406, 408, 410, 412 of the BCO 414 to the BPDO 416.

The BPDO, depicted in FIG. 5, starts by representing hierarchically the π-calculus language and defines mechanisms by which control and data may flow from one process or process fragment to another process or process fragment. The ontology kernel grows with concepts for differentiating data and control flow. Further on, channels between tasks may be specified. At this point, an ontologized business process may model inter/intra processes interaction and dataflow.

The leaf concepts in FIG. 5 may be instantiated for describing process sequences. All process parts are identifiable, which means that they should have a name or other identifier, such as a Universal Resource Identifier (“URI”) 502. The ontologized π-calculus of FIG. 5 has process as the top level concept. A process typically has a hasDefinition attribute (defining a π-process), and/or it may have a hasNext attribute, representing a sequence.

The concept Process has three sub-concepts: Process Call, used to make a call (i.e. transferring execution) to another process, passing some variable names; Multiple Path containing the attribute subdivide (listing process bifurcation); and Summation. Multiple Path is subdivided again into the π-calculus elements Exclusive Choice and Concurrent.

A Summation has the sub-concepts explained directly by the π-calculus syntax: Replication, Restriction and Prefix. Prefix is further specialized into Communication, concept which groups Input and Output channels; and Local, the unobservable action. Match is the last sub-concept of Prefix.

In some embodiments, there is the necessity to semantically annotate the type of communication channel. The possible types, in some embodiments include Data Flow and Control Flow, which results in introducing these two concepts in our ontology. The annotation is done by having a multiple inheritance from the concept Input or Output and Data Flow or Control Flow.

Moreover, Channels may annotate elements derived from the concept Communication. This annotation may contain information about Message Type and the Protocol (both attributes of Channel).

In some embodiments, the semantic annotation of processes or process fragments may be made using one or more of five defined relations illustrated in FIG. 6: hasBusinessGoal 602, hasBusinessFunction 604, hasBusinessDomain 606, hasBusinessRole 608, and hasBusinessResource 610. These relations group pairwise a Process or a ProcessFragment and respectively business goal 602, business function 604, business domain 606, business role 608, and business resource 610. A business goal 602 may identify one or more goals of a modeled process or process fragment. A business function 604 may define or describe a function of a process or process fragment. A business domain 606 may identify a domain the process or process fragment is a part of or applicable to, such as an industry which may include telecommunications, aerospace, defense, semiconductor, etc. A business role 608 may identify one or more roles of individuals or resources that are designated to perform the process or process fragment in whole or in part. A business resource 610 may identify one or more resources to be consumed by the process or process fragment, such as data, processing resources, commodities, or other consumable resources. In some embodiments, when the relation is built, it may cause the first parameter to become of type Semantic Fragment, which helps perform efficient semantic querying. Details of each of the annotations, according to some embodiments, is as follows:
hasBusinessFunction 604: uses the concepts from the Business Functions Ontology, which provides a structural breakdown of the organization's business functions. It does so by splitting the domain in two dimensions, namely horizontal and vertical. Horizontal dimension describes concepts such as Customer Relationship Management, Product Lifecycle Management, Supply Chain Management, Supply Relationship Management, etc. The vertical dimension describes concepts such as: procurement, manufacturing, warehousing, order fulfillment, etc. Concepts from this ontology classify process models by their functionality, independent of the business domain.
hasBusinessDomain 606: uses the concepts from Business Domain Ontology, which describes the domain inside the organization where the process is used. Examples of business domain concepts are: product, customer, provider, service, etc. Business Domain together with Business Function define the context of a process model.
hasBusinessRole 608: uses the concepts from Business Roles Ontology, which includes concepts representing roles in the organization e.g. Designer, Process Modeler, IT Expert, CEO. Concepts from this ontology are used to specify the role that performs a particular part of the process.
hasBusinessGoal 602: this concept defines what a process intends to achieve from a business point of view, it is used to capture the business functionality of a process artifact. Therefore, the concepts from aforementioned ontologies are used for specifying the Business Goal.
hasBusinessResource 610: this concept defines what resources a process will consume when performed. The resources may include one or more of a commodity, a processing resource, data, files, network bandwidth, and other resources, which may include a time element representing a period over which a resource may be consumed.

The BCO 414 illustrated in FIG. 4 may be instantiated to link the BPDO 416 via a link, such as a URI 502 to the BPDO of FIG. 5, to metadata defining a process or process fragment in a richly descriptive manner of goals 404, functions 406, domains 408, roles 410, and resources 412 that are applicable to the process or process fragment. Through the link, such as the URI 502, a BPDO for a specific domain, such as an industry domain, corporate domain, department domain, or other domain, may be imported. Such as domain may include domain specific or enhanced BCO or BPDO functionality, such as additional perspectives, data flows, control flows, or other domain specifics. Further, a BCO 414 may be associated with one or more other BCOs 414 that define at a smaller granularity, sub-processes or sub-process fragments that make up a larger process or process fragment. Thus, when a task, process, or process fragment is added to a process, a BCO is added to the model of the process basically as an empty container to hold metadata describing the functions, domains, roles, goals, and resources which will be subsequently specified by a person performing the process modeling.

To illustrate a use of such an ontology for business process description, an example process fragment 700 which performs customer order processing is illustrated in FIG. 7. Using a modeling tool, such as a graphical modeling tool, a process or process fragment 700 may be graphically modeled. The graphical model may be created in a “What-You-See-Is-What-You-Get” (“WVYSIYG”) type modeling tool by placing shapes representative of process elements, fragments, or smaller granularity processes on a palette. These elements may be linked. The elements and links may each include annotations, or properties, which may include the BCO 414 properties of goals 602, functions 604, domains 606, roles 608, and resources 610 which may be specified or edited in the modeling tool. However, the process fragment 700 may also, or alternatively include the annotations. Thus, each element of the process fragment 700 and/or the process fragment 700 itself, may be linked to concepts to import from a BCO 414. Such a link may be made through an instantiation of relations shown in FIG. 6. The annotations are typically richly descriptive metadata that may be used to provide the process perspectives described above. These perspectives, being richly descriptive typically provide contextual information about the process that are understandable not only to data processing mechanisms, but also to users to enable process definition and evaluation in a context understandable by business users, or in the context of other users depending on the environment within which the processes are defined.

Returning to FIG. 7, the example fragment 700 is composed of simple tasks including receiving a message 702, checking the order 704, an exclusive choice 706 for sending an order confirmation 708 or order rejection 710 message back, merging 712 for synchronization, and sending the response 714. The depiction of the process fragment 700 may be made using the BPMN notation. Each of the tasks may be a simple task available as general task types in the modeling tool or may be tasks previously defined as processes or process fragments. Thus, a process may be defined using other processes or process fragments as building blocks. At this point, the new process fragment has been defined.

As tasks are added to the process fragment 700 in a WYSIWYG modeling tool, a textual translation may be simultaneously generated or generated upon issuance of compile-like command through the modeling tool. This translation is typically made into an ontology modeling language, such as WSML, Web Ontology Language (“OWL”), Resource Description Framework (“RDF”), or other similar ontology modeling language. The following listing represents the process fragment 700 translated to BPDO according to an example embodiment. Each element has either a hasDefinition or hasNext attribute, if it continues the execution. If a task should go to sleep, it references the agent bpdo#Null.

LISTING 1 - WSML INSTANCE

1 wsmlVariant ” http://www.wsmo.org/wsml/wsml-syntax/wsml-flight ”
2 namespace { ” http://www.ip-super.org/business/process/example 1v2#”,
3 wsmostudio ” http://www.wsmostudio.org#”,
4 bco ” http://www.ip-super.org/ontologies/BCO/20070626#”,
5 bpdo ” http://www.ip-super.org/ontologies/BPDO/20070710#”,
6 dc ” http://purl.org/dc/elements/1.1#” }
7
8 ontology ” http://www.ip-super.org/business/process/example 1v2#”
9 nonFunctionalProperties
10 dc#contributor hasValue {”Alessandro Costa Pereira ” , ”Ivan Markovic ”} 11 endNonFunctionalProperties
11
12
13 importsOntology
14 { ” http://www.ip-super.org/ontologies/BPDO/20070710#”,
15 ” http://www.ip-super.org/ontologies/BCO/20070626#”}
16
17 /_{—}
18 _{—} This Process represents a simple sequence , for Ordering
19 _/
20 instance CustomerOrder memberOf bpdo#Process
21 bpdo#hasName hasValue ”Customer Order ”
22 bpdo#hasDefinition hasValue data 1
23
24 //Receive the data
25 instance data 1 memberOf {bpdo#Input , bpdo#DataFlow} 26 bpdo#hasName hasValue ” info ”
26
27 bpdo#hasNext hasValue checkOrder
28
29 // Process Something - Unobservable for the User
30 instance checkOrder memberOf bpdo#Local
31 bpdo#hasName hasValue ”Process Request ”
32 bpdo#hasNext hasValue decide 1
33
34 instance decide 1 memberOf bpdo#ExclusiveChoice
35 bpdo#hasName hasValue ” split ”
36 bpdo#subdivide hasValue { sendConfirmation , sendRejection }
37
38 //Send Confirmation : case 1
39 instance sendConfirmation memberOf {bpdo#Output , bpdo#DataFlow} 40 bpdo#hasName hasValue
”answer ”
40
41 bpdo#asName hasValue ”confirmation ”
42 bpdo#hasNext hasValue bpdo#Null
43
44 //Send Rejection : case 2
45 instance sendRejection memberOf {bpdo#Output , bpdo#DataFlow} 46 bpdo#hasName hasValue ”answer ”
46
47 bpdo#asName hasValue ” rejection ”
48 bpdo#hasNext hasValue bpdo#Null
49
50
51 //Merge after Exclusive Choice
52 instance mergeMessage memberOf bpdo#Process
53 bpdo#hasName hasValue ”Merge Message ”
54 bpdo#hasDefinition hasValue receive Info
55
56 //Receive info , and process it further calling it orderAnswer :
57 // It can be either Confirmation or Rejection
58 instance receive Info memberOf {bpdo#Input , bpdo#DataFlow} 59 bpdo#hasName hasValue ”answer ”
59
60 bpdo#asName hasValue ”orderAnswer ”
61 bpdo#hasNext hasValue process Internal
62
63 // Process Something
64 instance process Internal memberOf bpdo#Local
65 bpdo#hasName hasValue ”process Send ”
66 bpdo#hasNext hasValue sendResponse
67
68 //Send Response
69 instance sendResponse memberOf {bpdo#Output , bpdo#DataFlow} 70 bpdo#hasName hasValue
”orderAnswer ”
70
71 bpdo#hasNext hasValue bpdo#Null
72
73
74 /_{—}
75 _{—} Creating Business Goal , Function and Domains
76 _{—} These will be used to annotate processes ( Processes with definition )
77 _/
78
79 instance CustomerFeasible memberOf bco#BusinessFunction
80 bco#hasName hasValue ”DetermineCustomerOrderFeasibility ”
81 bco#hasDescription hasValue ”For proceeding , the Customer should be feasible to make an Order ”
82
83 instance DataAcquisition memberOf bco#BusinessFunction
84 bco#hasName hasValue ”Information Acquisition ”
85 bco#hasDescription hasValue ”Receiving data from Customer ”
86
87 instance Customer memberOf bco#BusinessDomain
88 bco#hasName hasValue ”CustomerDomain ”
89 bco#hasDescription hasValue ”Enterprise deals with Customers ”
90
91 /_{—}
92 _{—} Business Process Fragments
93 _{—} We will exemplify the annotation of one fragment
94 _/
95 instance fragment 1 memberOf bpdo#ProcessFragment
96 bpdo#constituent hasValue {data 1 , checkOrder } 97 // after checkOrder , hasNext has to be redefined
97
98
99 instance fragment 2 memberOf bpdo#ProcessFragment
100 bpdo#constituent hasValue { sendConfirmation }
101
102 instance fragment 3 memberOf bpdo#ProcessFragment
103 bpdo#constituent hasValue { sendRejection }
104
105 instance fragment 4 memberOf bpdo#ProcessFragment
106 bpdo#constituent hasValue { receive Info , process Internal ,sendResponse }
107
108 /_{—} 109 _{—} RelationInstances :
109
110 _{—} They connect together Processes and (Goal , Function or Domain)
111 _/
112 relation Instance bpdo#hasBusinessFunction (CustomerOrder , CustomerFeasible )
113
114 relation Instance bpdo#hasBusinessDomain (CustomerOrder , Customer )
115
116 relation Instance bpdo#hasBusinessFunction ( fragment 1, DataAcquisition )

This example is a process fragment 700, which may be composed with a respective task responsible for sending the message “Order”. Also, some parallel task may continue the execution, when receiving the message “Response.” The process is semantically annotated using the relation-Instance association between the agent and business core ontologies as illustrated in FIG. 4.

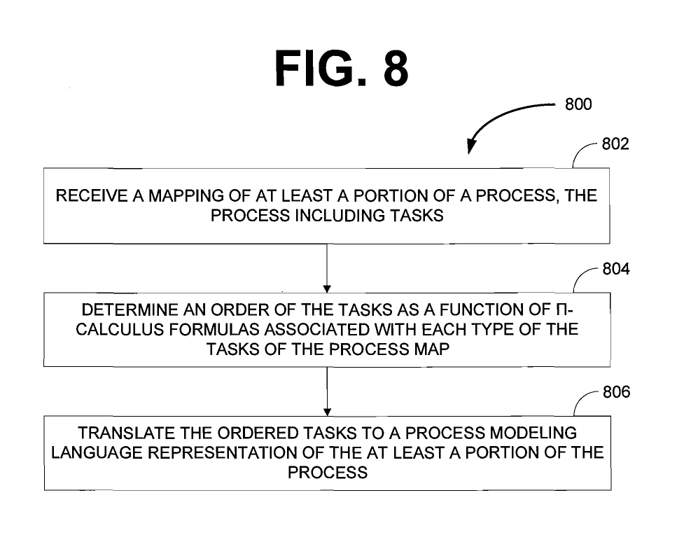

FIG. 8 is a block flow diagram of a method 800 according to an example embodiment. The example method 800 includes receiving a mapping of at least a portion of a process, the process including tasks 802 and determining an order of the tasks as a function of π-calculus formulas associated with each type of the tasks of the process map 804. The method 800 then translates the ordered tasks to a process modeling language representation of the at least a portion of the process 806. The process modeling language in some embodiments is WSML. The mapping of the at least a portion of the process in the method 800 is typically received from a process modeling tool.

In some embodiments, the mapping may include process elements selected from elements defined in a process ontology and the process elements may include properties defining one or more process or process element goals, functions, departments, roles, and resources. Process elements selected from elements defined in the process ontology may include the π-calculus formulas that enables reasoning when determining the order of the tasks.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A method comprising:
receiving a mapping and annotations of at least a portion of a process, the annotations including one or more tasks and metadata identifying one or more of associated roles, goals, resources, functions, and domains;
determining an order of the tasks as a function of calculus formulas associated with each type of the tasks of the process map; and
translating the ordered tasks to a process description modeling language representation of the at least a portion of the process, the translation including the annotations.

2. The method of claim 1, wherein the process description modeling language is Web Service Modeling Language (“WSML”).

3. The method of claim 1, wherein the mapping of the at least a portion of the process is received from a process modeling tool.

4. The method of claim 1, further comprising:
receiving a perspective query against one or more potential values of process model annotations; and
performing the query as a function of the process model annotations of the query.

5. The method of claim 4, wherein process tasks are described by π-calculus formulas that enables reasoning when determining the order of the tasks.

6. The method of claim 4, wherein a process ontology is domain specific and imports elements defined in a non-domain specific ontology.

7. A system comprising:
a process modeling tool operable to receive input defining a model of a process, the model of the process including tasks;
a data storage mechanism;
a process ontology translation module operable to:
receive a process model from the process modeling tool;
determine an order of tasks within the modeled process as a function of π-calculus formulas associated with each type of the tasks of the process map;
translate the ordered tasks to a process description modeling language representation of the at least a portion of the process; and
store the modeling language representation of the modeled process within the data storage mechanism.

8. The system of claim 7, wherein:
tasks included within the process model are selected from a number of task types available within a domain-specific process ontology;
the task types each include metadata defining properties of the task type, some properties of which are configurable when placed within a process model; and
one or more of the tasks are imported, in whole or in part, from a non-domain specific process ontology.

9. The system of claim 8, wherein the metadata of a task type includes one or more of metadata defining one or more process or task goals, functions, departments, roles, and resources.

10. The system of claim 8, wherein metadata of tasks included within the process model selected from a number the number of task types available within the domain-specific process ontology includes the π-calculus formulas that enable reasoning when determining the order of the tasks.

11. The system of claim 7, wherein the modeling language is Web Service Modeling Language (“WSML”).

12. The system of claim 7, wherein the process ontology translation module is a module included within the process modeling tool.

13. The system of claim 7, wherein the process ontology translation module is operable to identify workflow patterns within a modeled process as a function of the π-calculus formulas associated with each type of the tasks of the process map.

14. A machine-readable medium, with instructions thereon, which when processed by a machine, causes the machine to:
receive a mapping of at least a portion of a process, the process including tasks;
determine an order of the tasks as a function of π-calculus formulas associated with each type of the tasks of the process map; and
translate the ordered tasks to a process modeling description language representation of the at least a portion of the process.

15. The method of claim 14, wherein the process modeling language is Web Service Modeling Language (“WSML”).

16. The machine-readable medium of claim 14, wherein the mapping of the at least a portion of the process is received from a process modeling tool.

17. The machine-readable medium of claim 14, wherein:
the mapping includes process elements selected from elements defined in a process ontology; and
the process elements include properties defining one or more process or process element goals, functions, departments, roles, and resources.

18. The machine-readable medium of claim 17, wherein process elements selected from elements defined in the process ontology includes the π-calculus formulas that enables reasoning when determining the order of the tasks.

19. The machine-readable medium of claim 17, wherein a process ontology is domain specific and imports elements defined in a non-domain specific ontology.

20. The machine-readable medium of claim 14, determining an order of the tasks includes identifying workflow patterns within a modeled process as a function of the π-calculus formulas associated with each type of the tasks of the process map.
